(19) United States
(12) Patent Application Publication
(10) Pub. No.: US 2026/0113371 A1
(43) Pub. Date: Apr. 23, 2026

(54) INTERFACE FOR CONSOLIDATED OPERATION OF REMOTE CONNECTIONS

(71) Applicant: Truist Bank, Charlotte, NC (US)

(72) Inventors: Jamie Nathaniel Franklin, Charlotte, NC (US); Mary Margaret Mueller, Charlotte, NC (US)

(73) Assignee: Truist Bank, Charlotte, NC (US)

(21) Appl. No.: 18/918,651

(22) Filed: Oct. 17, 2024

(51) Int. Cl. H04L 67/025; G06F 3/0484

(52) U.S. Cl. CPC H04L 67/025; G06F 3/0484

(57) ABSTRACT

A system for consolidated operation of remote connections that generates a remote connection user interface utilized by end users to operate remote connections. The system determines whether transfer activity data includes transfers conducted as part of a remote connection. The remote connection has a destination identification that is displaced on the remote connection user interface. The remote connection is configured to enable the transmission of remote connection data between an end user computing device and a remote network. The system establishes a secure communication session with the remote network and transmits a command to the remote network in response to the selection of a function control component. The command modifies remote connection data stored to the remote network or causes the first remote network to return remote connection data. The remote connection data is incorporated into user interface assembly instructions transmitted to the end user computing device for display.

### TECHNICAL FIELD AND BACKGROUND

The present invention relates generally to systems, methods, and user interfaces for consolidated operation of remote connections.

The number of remote connections that enterprise organizations and individual users are required to operate has proliferated, which has resulted in a strain on organizations, users, and network resources. Remote connections commonly have distinct input and output functions, data inputs or outputs, authentication and security requirements, and different parameters that are utilized to operate the remote connection. Consequently, remote connections often require a separate software application or application programmable interface (“API”) to operate the connection. Alternatively, where multiple remote connections can be managed by a single software application, each remote connection requires a separate graphical user interface (“GUI” or “UI”) or portal to exchange data and commands with a remote network.

The increasing number of software applications and APIs, their varying modes of operation, and the sheer number of remote connections impose a significant burden on enterprises and individual users and needlessly consumes network and other resources. End users must learn different interfaces, comply with an array of security requirements, and periodically monitor remote connection parameters and utilization. In many cases, however, individual remote connection cannot be manually monitored to optimize resource utilization or to ensure that the remote connection is still required in the first place.

The present systems and methods address the above-described drawbacks by consolidating operation of remote connections in a manner that permits multiple remote connections to be operated in a single environment.

### SUMMARY

Disclosed are systems and methods for operating remote connections that include a computer with a processor and a memory device that stores data and executable code that, when executed, causes the processor to determine whether transfer activity data includes transfers that were made as part of maintaining one or more remote connections. The remote connections can be digital subscriptions through which a remote provider renders goods, services, or content to an end user (e.g., a music streaming service or retailer). The remote connections are configured to allow the transmission of remote connection data between an end user computing device and a remote network.

The remote connection data includes information about an end user account such as: (i) an user identification; (ii) a transfer destination identification that identifies the remote service provider; (iii) stored transfer source data (e.g., a credit card number or bank account number and routing information that is stored with the remote provider and used to process payments); (iv) plan data that relates to the package of goods, services, or content the end user receives through the remote connection (e.g., a basic account plan, premium account plan, etc.); or (v) remote connection transfer data, such as account statements or electronic transaction data reflecting payments to the remote provider.

After identifying remote connections, the system establishes a secure communication session with each of the remote networks. The system can establish the secure communication session in a manner that does not require the end user to input security data to the end user computing device. This can be accomplished by using a toke, certificate, or encryption key that is an indicator the end user or end user computing device were previously authenticated such that the authentication does not have to be repeated.

The system transmits a command to one of the remote networks in response to the selection of a function control component by an end user. The command can be a variety of functions used to operate the remote network, such as cancelling an account, modifying payment information, modifying a plan level, modifying account settings, or downloading historical account payment information and account usage information. The command can also modify remote connection data stored to the remote network or cause the remote network to return remote connection data that is incorporated into interface assembly instructions. The interface assembly instructions are transmitted to the end user computing device and executed to generate an user interface for display.

In one embodiment, the command is a cancel function that is processed by the first remote network to terminate the remote connection. In another embodiment, the command is a modify plan function, and the remote network processes the modify plan function to modify remote connection data by modifying a subscription level. Modifying the subscription level in turn reduces resource utilization through the remote connection. The command can be an activity function, and the remote network processes the activity function to return remote connection transfer data according to an end user selection.

One embodiment of the system includes a Remote Connection application programming interface (“API”) that converts the command to a format that complies with a communication protocol utilized by the first remote network.

The system optionally includes a neural network that performs the operation to determine whether transfer activity data includes transfers conducted through remote connections. This operation identifies remote connections through analysis of the transfer activity data. The neural network is made using an architecture selected from one of a convolutional neural network architecture, Long short-term memory network architecture, or a recurrent network architecture. The system can also identify remote connections by searching transfer destination identifications for keywords that match known remote connections. The system may also include connection identification software code that identifies remote connections by applying a set of rules to transfer activity data. The rules determine whether transfer activity data matches a known remote connection.

Another embodiment of the system is configured to perform an operation that classifies the remote connections to generate a classification code for each remote connection. The classification code is displayed by the end user computing device as a category of a remote connection (e.g., “entertainment,” “business,” or “educational”). The system can include a neural network that performs the operation that classifies the remote connections.

One embodiment of the system generates activity instructions for execution by the end user computing device. Executing the activity instructions reduces resource utilization through the first remote connection. The activity instructions can be generated by a neural network.

Another embodiment of the system executes stored interface assembly instructions. The stored interface assembly instructions include (i) a plurality of transfer destination identifications that each correspond to a remote connection implemented by a remote network, (ii) control components configured for selection by an end user, and (iii) remote connection transfer data. Executing the interface assembly instructions generates a Remote Connection graphical user interface (GUI), and the Remote Connection GUI displays the plurality of transfer destination identifications, the control components, and the remote connection transfer data. The system also establish a secure communication session with each of the remote networks without requiring the end user to input security data to the end user computing device. When the end user selects a control component, the system transmits a command to a remote network that implements a remote connection. The remote network processes the command to modify remote connection data stored to the first remote network, or cause the first remote network to return remote connection data that is transmitted to the end user computing device for display on the Remote Connection GUI.

### BRIEF DESCRIPTION OF THE DRAWINGS

Features, aspects, and advantages of the present invention are better understood when the following detailed description of the invention is read with reference to the accompanying figures, in which:

FIG. 1 is an example system diagram according to one embodiment.

FIG. 2A is a diagram of a feedforward network, according to at least one embodiment, utilized in machine learning.

FIG. 2B is a diagram of a convolution neural network, according to at least one embodiment, utilized in machine learning.

FIG. 2C is a diagram of a portion of the convolution neural network of FIG. 2B, according to at least one embodiment, illustrating assigned weights at connections or neurons.

FIG. 3 is a diagram representing an example weighted sum computation in a node in an artificial neural network.

FIG. 4 is a diagram of a Recurrent Neural Network RNN, according to at least one embodiment, utilized in machine learning.

FIG. 5 is a schematic logic diagram of an artificial intelligence program including a front-end and a back-end algorithm.

FIG. 6 is a flow chart representing a method model development and deployment by machine learning.

FIG. 7 is an example graphical user interface.

### DETAILED DESCRIPTION

The present invention will now be described more fully hereinafter with reference to the accompanying drawings in which example embodiments of the invention are shown. However, the invention may be embodied in many different forms and should not be construed as limited to the representative embodiments set forth herein. The example embodiments are provided so that this disclosure will be both thorough and complete and will fully convey the scope of the invention and enable one of ordinary skill in the art to make, use, and practice the invention. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

As used herein, the terms “enterprise” or “provider” generally describes a person or business that provides goods or services as well as access to proprietary software that generates one or more GUIs that facilitate access to the goods or services. The term “user” is used interchangeably with the terms end user, customer or consumer and represents individuals who operate computing devices that use the systems and methods disclosed in this application for viewing and navigating GUIs. The provider may render services or provide goods to the end user as part of one or more transactions or as part of an ongoing customer relationship that utilizes the technology described in this application for enhancing efficient navigation of user interfaces that are used as part of providing goods and services.

As used herein, an “interface” is a component of computer executable instructions stored in a tangible, non-transitory medium and executed by a processor to present a display of information related to the interface allowing someone to view and/or interact with the presented information. An interface may be embodied within a hardware component such as a laptop computer, cellular smart phone, or a dedicated purpose device such as a kiosk or point of sale device (e.g., a cash register). An interface may be a GUI when the interface includes graphical elements that allow users to input, retrieve, read, and interact with data. The term “input function” refers to an element on a user interface that allows users to input data, such as a text box, radio button, pull down menu, drop down menu, icon, or hyperlink, among others. The term input function is used interchangeably with the terms control component or control function.

An Application Programming Interface, or API, is a type of software interface that includes a set of rules and protocols that define how software applications communicate with each other using requests and responses. APIs can incorporate existing application functions into new software applications. The API can function to translate commands and data formats from one computing device to corresponding commands and data formats used in another computing device. In some cases, APIs adhere to specific standards, such as hypertext markup language (“html”) and Representational State Transfer (“REST”).

Embodiments are described with reference to flowchart illustrations or block diagrams of methods or apparatuses where each block or combinations of blocks can be implemented by computer-readable instructions (i.e., software). The term apparatus includes systems and computer program products. The referenced computer-readable software instructions may be provided to a processor of a general purpose computer, special purpose computer, or other programmable data processing apparatus to produce a particular machine. The instructions, which execute via the processor of the computer or other programmable data processing apparatus, create mechanisms for implementing the functions specified in this specification and attached figures.

The computer-readable instructions are loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the attached flowchart(s) or block diagram(s). Alternatively, computer software implemented steps or acts may be combined with operator or human implemented steps or acts in order to carry out an embodiment of the disclosed systems and methods.

The computer-readable software instructions may also be stored in a computer-readable memory that can direct a computer or other programmable data processing apparatus to function in a particular manner. In this manner, the instructions stored in the computer-readable memory produce an article of manufacture that includes the instructions, which implement the functions described and illustrated herein.

### System Level Description

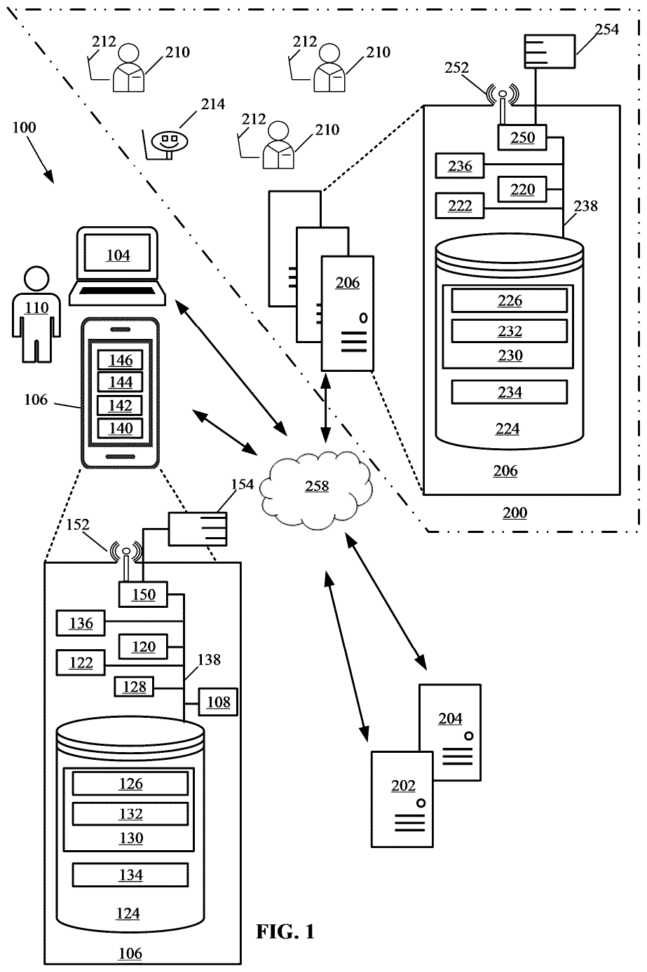

As shown in FIG. 1, a hardware system 100 configuration according to one embodiment generally includes a user 110 that benefits through use of services and products offered by a provider through an enterprise system 200. The user 110 accesses services and products by use of one or more user computing devices 104 & 106. The user computing device can be a larger device, such as a laptop or desktop computer 104, or a mobile computing device 106, such as smart phone or tablet device with processing and communication capabilities. The user computing device 104 & 106 includes integrated software applications that manage device resources, generate user interfaces, accept user inputs, and facilitate communications with other devices, among other functions. The integrated software applications can include an operating system, such as Linux®, UNIX®, Windows®, macOS®, iOS®, Android®, or other operating system compatible with personal computing devices.

The user 110 can be an individual, a group, or an entity having access to the user computing device 104 & 106. Although the user 110 is singly represented in some figures, at least in some embodiments, the user 110 is one of many, such as a market or community of users, consumers, customers, business entities, government entities, and groups of any size.

The user computing device includes subsystems and components, such as a processor 120, a memory device 122, a storage device 124, or power system 128. The memory device 122 can be transitory random access memory (“RAM”) or read-only memory (“ROM”). The storage device 124 includes at least one of a non-transitory storage medium for long-term, intermediate-term, and short-term storage of computer-readable instructions 126 for execution by the processor 120. For example, the instructions 126 can include instructions for an operating system and various integrated applications or programs 130 & 132. The storage device 124 can store various other data items 134, including, without limitation, cached data, user files, pictures, audio and/or video recordings, files downloaded or received from other devices, and other data items preferred by the user, or related to any or all of the applications or programs.

The memory device 122 and storage device 124 are operatively coupled to the processor 120 and are configures to store a plurality of integrated software applications that comprise computer-executable instructions and code executed by the processing device 120 to implement the functions of the user computing device 104 & 106 described herein. Example applications include a conventional Internet browser software application and a mobile software application created by the provider to facilitate interaction with the provider system 200.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The integrated software applications also typically provide a graphical user interface (“GUI”) on the user computing device display screen 140 that allows the user 110 to utilize and interact with the user computing device. Example GUI display screens are depicted in the attached figures. The GUI display screens may include control functions for displaying information and accepting inputs from users, such as text boxes, data fields, hyperlinks, pull down menus, check boxes, radio buttons, and the like. One of ordinary skill in the art will appreciate that the example functions and user-interface display screens shown in the attached figures are not intended to be limiting, and an integrated software application may include other display screens and functions.

The processing device 120 performs calculations, processes instructions for execution, and manipulates information. The processing device 120 executes machine-readable instructions stored in the storage device 124 and/or memory device 122 to perform methods and functions as described or implied herein. The processing device 120 can be implemented as a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120. In other embodiments, the methods and functions described herein include cloud-based computing such that the processing device 120 facilitates local operations, such communication functions, data transfer, and user inputs and outputs.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user computing device 104 & 106 may also include a positioning device 108, such as a global positioning system device (“GPS”) that determines a location of the user computing device. In other embodiments, the positioning device 108 includes a proximity sensor or transmitter, such as an RFID tag, that can sense or be sensed by devices proximal to the user computing device 104 & 106.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

A system intraconnect 138, such as a bus system, connects various components of the mobile device 106. The user computing device 104 & 106 further includes a communication interface 150. The communication interface 150 facilitates transactions with other devices and systems to provide two-way communications and data exchanges through a wireless communication device 152 or wired connection 154. Communications may be conducted via various modes or protocols, such as through a cellular network, wireless communication protocols using IEEE 802.11 standards. Communications can also include short-range protocols, such as Bluetooth or Near-field communication protocols. Communications may also or alternatively be conducted via the connector 154 for wired connections such by USB, Ethernet, and other physically connected modes of data transfer.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 act on behalf of the provider, such as customer service representatives, advisors, managers, and sales team members.

Human agents 210 utilize agent computing devices 212 to interface with the provider system 200. The agent computing devices 212 can be, as non-limiting examples, computing devices, kiosks, terminals, smart devices such as phones, and devices and tools at customer service counters and windows at POS locations. In at least one example, the diagrammatic representation and above-description of the components of the user computing device 104 & 106 in FIG. 1 applies as well to the agent computing devices 212. As used herein, the general term “end user computing device” can be used to refer to either the agent computing device 212 or the user 110 depending on whether the agent (as an employee or affiliate of the provider) or the user (as a customer or consumer) is utilizing the disclosed systems and methods to segment, parse, filter, analyze, and display content data.

Human agents 210 interact with users 110 or other agents 212 by phone, via an instant messaging software application, or by email. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components, such as a processor device 220, an input-output system 236, an intraconnect bus system 238, a communication interface 250, a wireless device 252, a hardwire connection device 254, a transitory memory device 222, and a non-transitory storage device 224 for long-term, intermediate-term, and short-term storage of computer-readable instructions 226 for execution by the processor device 220. The instructions 226 can include instructions for an operating system and various software applications or programs 230 & 232. The storage device 224 can store various other data 234, such as cached data, files for user accounts, user profiles, account balances, and transaction histories, files downloaded or received from other devices, and other data items required or related to the applications or programs 230 & 232.

The network 258 provides wireless or wired communications among the components of the hardware system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations.

The network 258 may be or include an enterprise or secured network, or may be implemented, at least in part, through one or more connections to the Internet. A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated hardware system 100.

External systems 202 and 204 represent any number and variety of data sources, users, consumers, customers, enterprises, and groups of any size. In at least one example, the external systems 202 and 204 represent remote terminal utilized by the enterprise system 200 in serving users 110. In another example, the external systems 202 and 204 represent electronic systems for processing payment transactions. The system may also utilize software applications that function using external resources 202 and 204 available through a third-party provider, such as a Software as a Service (“SasS”), Platform as a Service (“PaaS”), or Infrastructure as a Service (“IaaS”) provider running on a third-party cloud service computing device. For instance, a cloud computing device may function as a resource provider by providing remote data storage capabilities or running software applications utilized by remote devices.

SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

The embodiment shown in FIG. 1 is not intended to be limiting, and one of ordinary skill in the art will appreciate that the system and methods of the present invention may be implemented using other suitable hardware or software configurations. For example, the system may utilize only a single computing system 206 implemented by one or more physical or virtual computing devices, or a single computing device may implement one or more of the computing system 206, agent computing system 206, or user computing device 104 & 106.

### Artificial Intelligence and Neural Network Architecture

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (“KNN”), and the like. Additionally or alternatively, the machine learning algorithm may include one or more regression algorithms configured to output a numerical value in response to a given input. Further, the machine learning may include one or more pattern recognition algorithms—e.g., a module, subroutine or the like capable of translating text or string characters and/or a speech recognition module or subroutine. The machine learning modules may include a machine learning acceleration logic (e.g., a fixed function matrix multiplication logic) that implements the stored processes or optimizes the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (e.g., DBSCAN), mean shift clustering, expectation maximization (e.g., EM) clustering using Gaussian mixture models (e.g., GMM), agglomerative hierarchical clustering, or the like. In one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

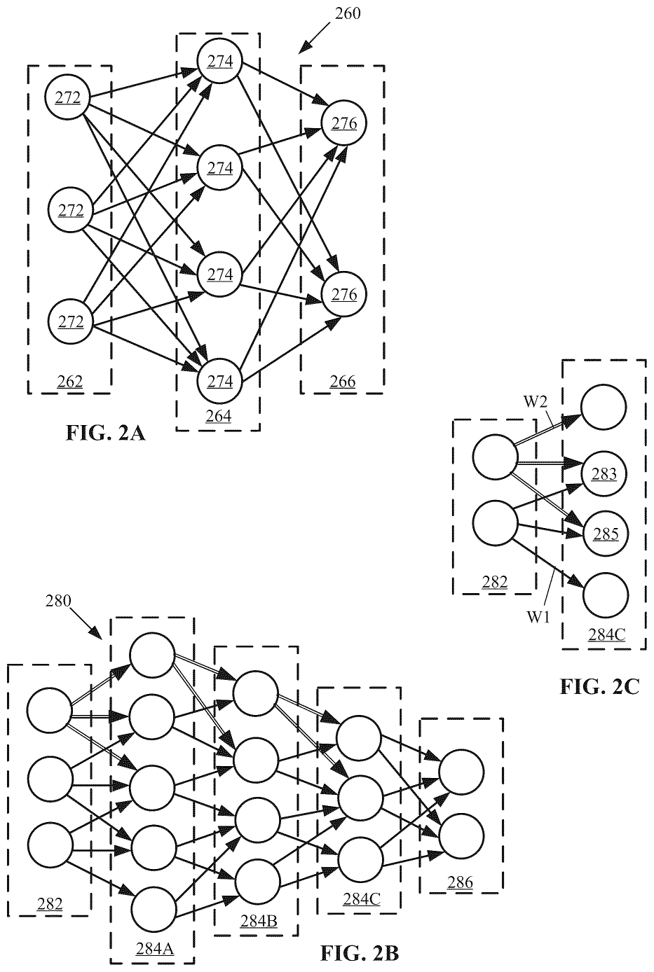

A feedforward network 260 (as depicted in FIG. 2A) may include a topography with a hidden layer 264 between an input layer 262 and an output layer 266. The input layer 262 includes input nodes 272 that communicate input data, variables, matrices, or the like to the hidden layer 264 that is implemented with hidden layer nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge.

In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers. That is, the hidden layer 264 implements activation functions between the input data communicated from the input layer 262 and the output data communicated to the nodes 276 of the output layer 266.

It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem.

Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient (e.g., a propagated value). The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An additional or alternative type of neural network suitable for use in the machine learning program and/or module is a Convolutional Neural Network (“CNN”). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program.

A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An example convolutional neural network CNN is depicted and referenced as 280 in FIG. 2B. As in the basic feedforward network 260 of FIG. 2A, the illustrated example of FIG. 2B has an input layer 282 and an output layer 286. However where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

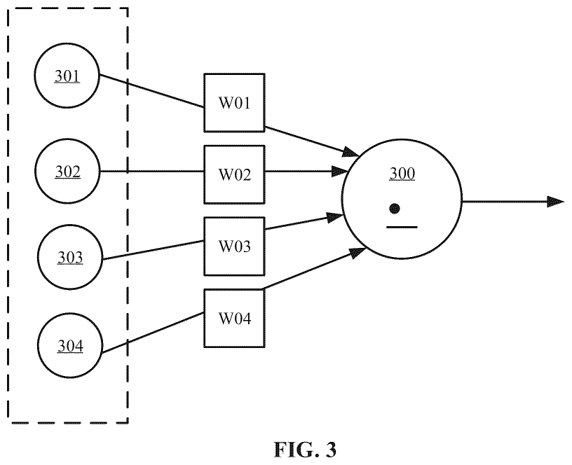

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional type of feedforward neural network suitable for use in the machine learning program and/or module is a Recurrent Neural Network (“RNN”). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter. That is, at least a portion of the output data from the RNN may be used as feedback or input in calculating subsequent output data. In some embodiments, the machine learning module may include an RNN configured for language processing (e.g., an RNN configured to perform statistical language modeling to predict the next word in a string based on the previous words). The RNN(s) of the machine learning program may include a feedback system suitable to provide the connection(s) between subsequent and previous layers of the network.

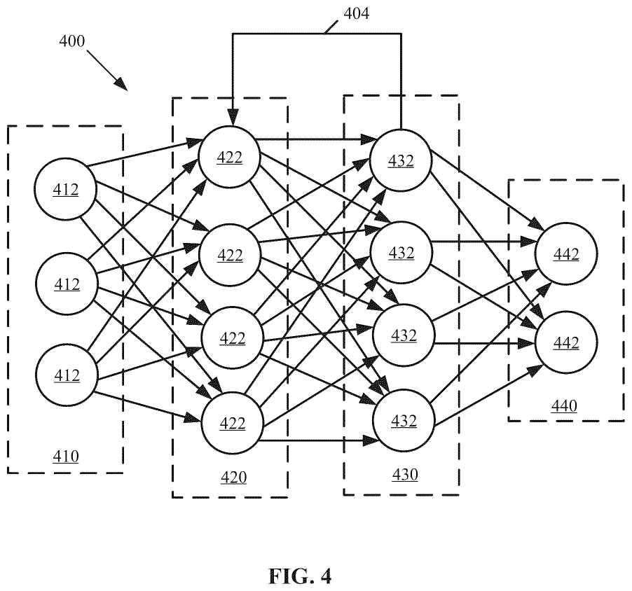

An example RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more nodes of a subsequent layer may provide or communicate a parameter or other data to a previous layer of the RNN network 400. Moreover, in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them (i.e., nodes of nonsequential layers of the RNN 400).

In an additional or alternative embodiment, the machine learning program may include one or more support vector machines. A support vector machine may be configured to determine a category to which input data belongs. For example, the machine learning program may be configured to define a margin using a combination of two or more of the input variables and/or data points as support vectors to maximize the determined margin. Such a margin may generally correspond to a distance between the closest vectors that are classified differently. The machine learning program may be configured to utilize a plurality of support vector machines to perform a single classification. For example, the machine learning program may determine the category to which input data belongs using a first support vector determined from first and second data points/variables, and the machine learning program may independently categorize the input data using a second support vector determined from third and fourth data points/variables. The support vector machine(s) may be trained similarly to the training of neural networks (e.g., by providing a known input vector, including values for the input variables) and a known output classification. The support vector machine is trained by selecting the support vectors and/or a portion of the input vectors that maximize the determined margin.

As depicted, and in some embodiments, the machine learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers).

Generally, the neural network(s) of the machine learning program may include a relatively large number of layers (e.g., three or more layers) and are referred to as deep neural networks. For example, the node of each hidden layer of a neural network may be associated with an activation function utilized by the machine learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

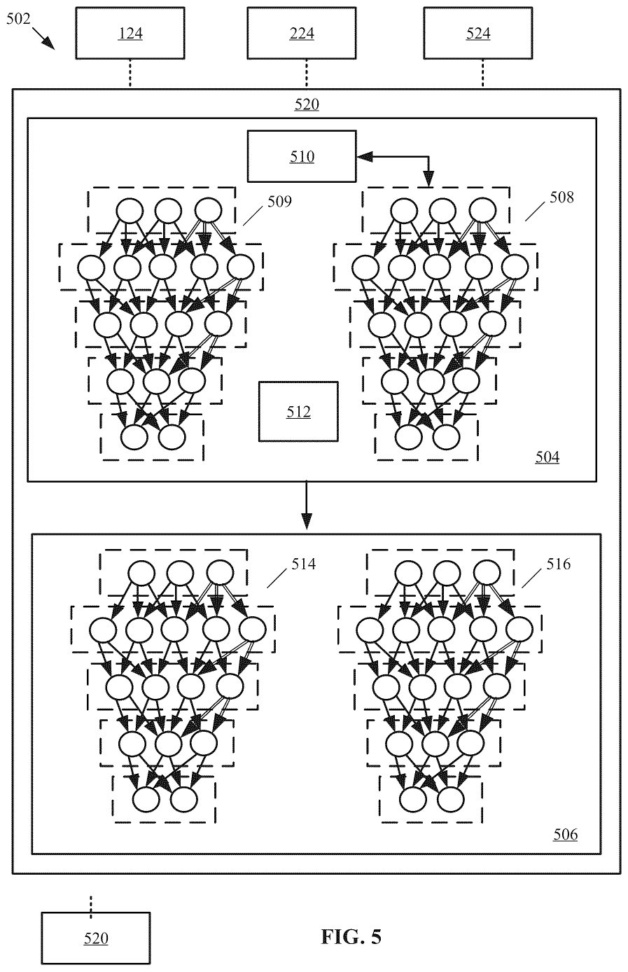

Referring now to FIG. 5 and some embodiments, an artificial intelligence program 502 may include a front-end algorithm 504 and a back-end algorithm 506. The artificial intelligence program 502 may be implemented on an AI processor 520. The instructions associated with the front-end algorithm 504 and the back-end algorithm 506 may be stored in an associated memory device and/or storage device of the system (e.g., storage device 124, memory device 122, storage device 124, and/or memory device 222) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end algorithm 506 configured to perform an operation on the data set communicated directly or indirectly to the back-end algorithm 506). For instance, the front-end algorithm 504 can include at least one CNN 508 communicatively coupled to send output data to the back-end algorithm 506.

Additionally or alternatively, the front-end algorithm 504 can include one or more AI algorithms 510, 512 (e.g., statistical models or machine learning programs such as decision tree learning, associate rule learning, recurrent artificial neural networks, support vector machines, and the like). In various embodiments, the front-end algorithm 504 may be configured to include built in training and inference logic or suitable software to train the neural network prior to use (e.g., machine learning logic including, but not limited to, image recognition, mapping and localization, autonomous navigation, speech synthesis, document imaging, or language translation, such as natural language processing). For example, a CNN 508 and/or AI algorithm 510 may be used for image recognition, input categorization, and/or support vector training.

In some embodiments and within the front-end algorithm 504, an output from an AI algorithm 510 may be communicated to a CNN 508 or 509, which processes the data before communicating an output from the CNN 508, 509 and/or the front-end algorithm 504 to the back-end program 506. In various embodiments, the back-end network 506 may be configured to implement input and/or model classification, speech recognition, translation, and the like. For instance, the back-end network 506 may include one or more CNNs (e.g,, CNN 514) or dense networks (e.g., dense networks 516), as described herein.

For instance and in some embodiments of the AI program 502, the program may be configured to perform unsupervised learning, in which the machine learning program performs the training process using unlabeled data (e.g., without known output data with which to compare). During such unsupervised learning, the neural network may be configured to generate groupings of the input data and/or determine how individual input data points are related to the complete input data set (e.g., via the front-end algorithm 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known (e.g., a mix of labeled and unlabeled data having the same distribution).

In some embodiments, the AI program 502 may be accelerated via AI processor 520 (e.g., hardware). The machine learning framework may include an index of basic operations, subroutines, and the like (primitives) typically implemented by AI and/or machine learning algorithms. Thus, the AI program 502 may be configured to utilize the primitives of the AI processor 520 to perform some or all of the calculations required by the AI program 502. Primitives suitable for inclusion in the AI processor 520 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine learning program may include variations, adaptations, and alternatives suitable to perform the operations necessary for the system, and the present disclosure is equally applicable to such suitably configured machine learning and/or artificial intelligence programs, modules, etc. For instance, the machine learning program may include one or more long short-term memory (“LSTM”) RNNs, convolutional deep belief networks, deep belief networks DBNs, and the like. DBNs, for instance, may be utilized to pre-train the weighted characteristics and/or parameters using an unsupervised learning process. Further, the machine learning module may include one or more other machine learning tools (e.g., Logistic Regression (“LR”), Naive-Bayes, Random Forest (“RF”), matrix factorization, and support vector machines) in addition to, or as an alternative to, one or more neural networks, as described herein.

Those of skill in the art will also appreciate that other types of neural networks may be used to implement the systems and methods disclosed herein, including, without limitation, radial basis networks, deep feed forward networks, gated recurrent unit networks, auto encoder networks, variational auto encoder networks, Markov chain networks, Hopefield Networks, Boltzman machine networks, deep belief networks, deep convolutional networks, deconvolutional networks, deep convolutional inverse graphics networks, generative adversarial networks, liquid state machines, extreme learning machines, echo state networks, deep residual networks, Kohonen networks, and neural turning machine networks, as well as other types of neural networks known to those of skill in the art.

To implement natural language processing technology, suitable neural network architectures can include, without limitation: (i) multilayer perceptron (“MLP”) networks having three or more layers and that utilizes a nonlinear activation function (mainly hyperbolic tangent or logistic function) that allows the network to classify data that is not linearly separable; (ii) convolutional neural networks; (iii) recursive neural networks; (iv) recurrent neural networks; (v) Long Short-Term Memory (“LSTM”) network architecture; (vi) Bidirectional Long Short-Term Memory network architecture, which is an improvement upon LSTM by analyzing word, or communication element, sequences in forward and backward directions; (vii) Sequence-to-Sequence networks; and (viii) shallow neural networks such as word2vec (i.e., a group of shallow two-layer models used for producing word embedding that takes a large corpus of alphanumeric content data as input to produces a vector space where every word or communication element in the content data corpus obtains the corresponding vector in the space).

With respect to clustering software processing techniques that implement unsupervised learning, suitable neural network architectures can include, but are not limited to: (i) Hopefield Networks; (ii) a Boltzmann Machines; (iii) a Sigmoid Belief Net; (iv) Deep Belief Networks; (v) a Helmholtz Machine; (vi) a Kohonen Network where each neuron of an output layer holds a vector with a dimensionality equal to the number of neurons in the input layer, and in turn, the number of neurons in the input layer is equal to the dimensionality of data points given to the network; (vii) a Self-Organizing Map (“SOM”) having a set of neurons connected to form a topological grid (usually rectangular) that, when presented with a pattern, the neuron with closest weight vector is considered to be the output with the neuron's weight adapted to the pattern, as well as the weights of neighboring neurons, to naturally find data clusters; and (viii) a Centroid Neural Network that is premised on Kmeans clustering software processing techniques.

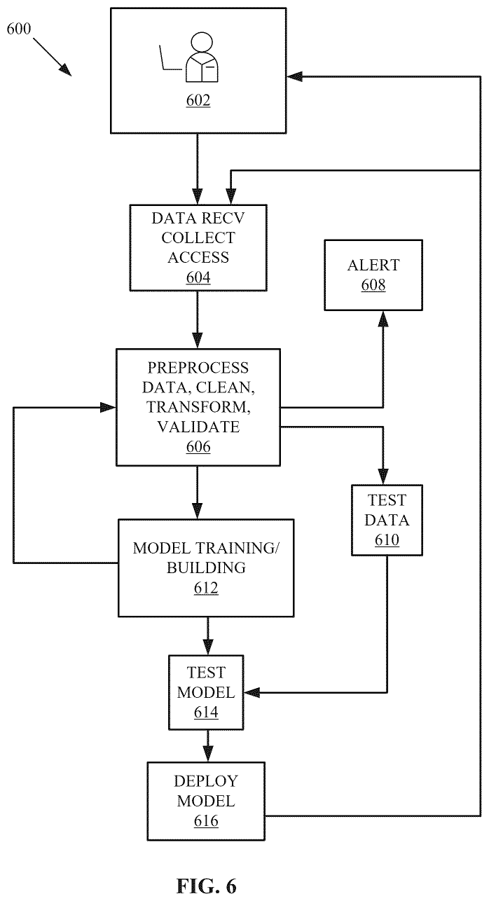

Turning to FIG. 6, a flow chart representing a method 600, according to at least one embodiment, of model development and deployment by machine learning. The method 600 represents at least one example of a machine learning workflow in which steps are implemented in a machine learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop.

In step 604, user evaluation data is received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated.

Step 606 can include data validation to confirm that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (i.e., the model is underfitted), the system may automatically determine that the threshold level of accuracy is not satisfied and may adjust the weights for a subsequent iteration of the training and testing loop. The weights may be iteratively adjusted during each iteration of the training and testing loop based on the comparison to the threshold level of accuracy. However, there is a balance for training the model in order to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained. In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using calculated derivatives to minimize a loss function. Backpropagation may be used to calculate the gradient of the error function with respect to the neural network's weights.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see step 616) and the feedback loop automatically provides feedback for further training of the machine learning model to improve its performance, and upon completion of the other method steps such as 612, the machine learning model that has been automatically retrained based on the feedback loop is then redeployed (step 614). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions to detecting anomalies in order to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security. For example, the system may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

### Interfacing With a Provider System

A provider can develop, distribute, and maintain one or more proprietary software applications and systems that end users utilize to access a provider's system by navigating a series of graphical user interfaces displayed on an end user computing device. End user computing devices access the provider system using an Internet browser software application to communicate with a webserver or other network computing devices maintained by the provider. The provider system transmits executable software code and other data that, when processed by the end user computing device, renders a website on a display screen of the end user computing device.

Alternatively, end user computing devices access the provider system through a software application installed on the end user computing device that displays one or more graphical user interfaces rendered in part using data received from the provider system. An example is a provider mobile software application that is downloaded to the end user computing device and configured to render a series of graphical user interfaces on a mobile device, such as a cellular smart phone or tablet computer.

With respect to website graphical user interfaces, to access the provider's system, the end user computing device first transmits an interface instruction request to a webserver or network device maintained on the provider system. The interface instruction request can include: (i) an Internet Protocol (“IP”) address for the end user computing device; (ii) navigation data; and (iii) system configuration data. In response to the interface instruction request, the webserver returns interface assembly instructions and a digital cookie that is stored to the end user computing device and used to track functions and activities performed by the end user computing device.

The interface assembly instructions are implemented as executable software code that is processed by the end user computing device to generate a graphical user interface that is displayed on the end user computing device screen. The interface assembly instructions determine various elements of a graphical user interface and how those elements are displayed. Elements of the graphical user interface include containers, such as frames and panels, that partition the graphical user interface into smaller sections that display numerical data, text, or control functions that accept end user inputs (e.g., radio buttons, push buttons, pull-down menus, hyperlinks, and the like). The interface assembly instructions also determine the layout, existence, and number of various components, such as labels, text input fields, buttons, pull-down menus, toolbars, and hyperlinks, among others.

Containers can be top-level containers that incorporate one or more sub-level containers, such as a large frame or panel that includes multiple small panels within the larger frame or panel. In other cases, the top-level container is displayed as a separate user interface from the sub-level container where the top-level container is a “main” or “primary” user interface, and end users select a navigation control component to display a sub-level container as a secondary user interface of the same type. As an example, the top-level container might be a first Remote Connection user interface that displays end user data such as five of ten remote connections licensed or operated by an end user, and the sub-level container is a second Remote Connection user interface that displays supplemental end user data such as the next five remote connections operated by the end user.

The sub-level container could also be implemented as an expanded version of the top-level container, such as where the top-level container is an user interface that shows five of ten end user profile attributes, and the sub-level container is displayed by selecting an “expand” control component to show supplemental end user data that includes all ten end user attributes in a single graphical user interface of an expanded length. Thus, the top-level container could be a condensed or summary view, and the sub-level container is displayed as an expanded or full view.

The interface assembly instructions can be implemented with software code formats such as hypertext markup language (“html”), Cascading Style Sheets (“CSS”), ACTIVEX, and JAVASCRIPT, among other suitable software languages and settings files. Cascading Style Sheets are instructions that control various aspects of a user interface, such as color, font type, text size, the spacing between elements on the user interface, how elements are positioned and laid out, the background images, background colors, and variations in the display for different computing device types, screen sizes, and operating systems. The Cascading Style Sheets are “cascading” in the sense that a setting applied to a parent or top-level element will also apply to all sub-level or child elements. For instance, if the color of body text is set to “blue,” then headings, paragraphs, and other text elements within the body will also be set to the same color.

The interface assembly instructions can include software code that initiates the execution of local software application packages stored to an end user computing device. For instance, the interface assembly instructions can generate a graphical user interface that displays a control component input function that launches a separate portable document format (“PDF”) viewer, that displays an icon integrated with or displayed on top of an Internet browser software application, or that opens a separate “popup” window to accept an username and password.

The interface assembly instructions can include general instructions that are sent to all system users as well as end user specific data and instructions. End user specific instructions include settings that apply to specific users. End user settings are user inputs that define the type of data displayed and the manner in which such data is displayed, such as preferences and customization settings for the various software applications utilized by the end user. Settings can be stored to a profile data file stored to a provider system or an end user computing device that is accessed by the interface assembly instructions. The profile data file can include instructions for the operating system used by the end user computing device that establish parameters such as specifying the icons, control components (i.e., input functions), shortcuts, and bookmarks utilized by a particular end user. The end user profile further includes other customization information including, without limitation, color schemes, font settings, background images, and graphical user interface layout information that determines the position, size, and arrangement of containers, control components, and other elements of a graphical user interface.

The profile data file can be stored to a provider system and downloaded at the commencement of communication session between the end user computing device and the provider system. The profile data file is utilized by software applications running on the end user computing device to customize the display of graphical user interfaces. The end user profile can be modified by, for example, modifying a display “zoom” magnification, changing display colors, or adding a control component. Such modifications are reported back to the provider system either as they occur, or at the end of a communication session with the provider system. This allows the user profile and user files located on the end user computing device to be synchronized with that stored in the End User Database (discussed below).

End user specific data can include content data that applies to a given end user, such as an end user identification (e.g., username or number), contact information (e.g., an email address), end user product identification data (e.g., account numbers or account names), and end user resource availability data (e.g., an account balance). End user specific data is generally transmitted from a provider system and displayed on the end user computing device within the framework of a graphical user interface. To illustrate, the interface assembly instructions may include software code that establishes a frame in a graphical user interface having fields of “account name” and “monthly cost.” The interface assembly instructions can also include software code that instructs the end use computing device to request product identification data and transaction data from the provider system. The product identification is displayed in the account name field while relevant portions of the transaction data is displayed in the monthly cost field.

In some embodiments, the navigation data and system configuration data are utilized by the provider system to generate the interface assembly instructions. For instance, the system configuration data may indicate that the end user computing device is utilizing a particular Internet browser or mobile software application to communicate with the provider system. The provider system then generates interface assembly instructions that are compatible with, and readable by, the particular Internet browser or mobile software application. As another example, if the navigation data indicate the end user computing device previously visited a provider webpage, the provider display data can include instructions for displaying a customized message on the end user computing device, such as “Welcome back Patrick! ” Navigation data transmitted by the end user computing device generally includes information relating to prior functions and activities performed by the end user computing device. Examples of navigation data include: (i) navigation history data (i.e., identifiers like website names and IP addresses showing websites previously access by the end user computing device); (ii) redirect data (i.e., data indicating whether the end user computing device selected a third-party universal resource locator (“URL”) link that redirected to the provider web server); and (iii) search history data (e.g., data showing keyword searches in a search engine, like Google® or Bing®, performed by the end user computing device).

Navigation history data allows a provider to determine whether an end user computing device was previously used to visit particular websites, including the provider's own website. The navigation history data further indicates whether the end user computing device accessed relevant third-party websites, such as websites associated with a remote connection. The navigation history data includes, without limitation: (i) URL data identifying a hyperlink link to the website; (ii) website identification data, such as a title of a visited website; (iii) website IP address data indicating an IP address for a web server associated with a visited website; and (iv) time stamp data indicating the date and time when a website was accessed.

Redirect data may indicate whether the end user computing device selected a hyperlink or control component that redirected the end user computing device to a different website, domain or network. For instance, an end user viewing a Remote Connection GUI might select an icon or control component associated with a remote connection. If the end user computing device is not authenticated to the remote provider network that is hosting the remote connection, the end user can be redirected to a login webpage hosted by the remote provider network where the end user enters security or authentication data, such as an username and password. The end user computing device can then be redirected back to the Remote Connection GUI.

Search history data is generated when an end user computing device runs a query within a search engine. The search history data can include, without limitation: (i) a search engine identification indicating the search engine that was utilized; (ii) search parameter data indicating the alphanumeric strings or operators used as part of a search query (e.g., Boolean operators such as “AND” or “OR” or functional operators, like “insite” used to search the contents of a specific website); and (iii) time stamp data indicating the date and time a search was performed.

The end user computing device may also transmit system configuration data to the provider system that is used to evaluate a user or authenticate the end user computing device. System configuration data can include, without limitation: (i) a unique identification for the end user computing device (e.g., a media access control (“MAC”) address hardcoded into a communication subsystem of the end user computing device); (ii) a MAC address for the local network of an end user computing device (e.g., a router MAC address); (iii) copies of key system files that are unlikely to change between instances when a user accesses the provider system; and (iv) a list of software applications running or installed on the end user computing device.

The provider system can determine location data for the user computing device based on the user device IP address. The provider system includes a software application that transmits the user device IP address to an Identity & Location API that utilizes the device IP address to determine an approximate geographic location of the user computing device. The Identity & Location API passes the user device IP address to a database or a third-party software service that returns geographic location data for the user device IP address, such as a city, county, or state. The Identity & Location API stores the geographic data to a database record on the provider system in an End User Database, as discussed in more detail below.

The end user computing device optionally authenticates to the provider system if, for instance, the end user has an existing electronic account with the provider. The end user computing device navigates to a login interface and enters user security data, such as an username and password. The end user selects a submit function on an user interface display screen to transmit an user authentication request message that includes the user security data to the provider system. In some embodiments, the end user security data and user authentication request message can further include elements of the system configuration data that are used to authenticate the user, such as an end user computing device identification or Internet protocol address.

The provider system performs a verification analysis to verify the identity of the end user or the end user computing device. The verification analysis can compare the received user security data to stored user security data to determine whether the security data sets match. In this manner, the provider system determines whether a correct user name, password, device identification, or other security data is received. The provider system generates an authentication notification message. The authentication notification message includes a verification flag indicating whether the verification passed or failed and a reason for any failed authentication, such as an unrecognized user name, password, or end user computing device identification.

The user authentication request message can also include system configuration data used to perform the verification process. As one example, the provider system might store an end user computing device MAC address to an End User Database record as part of the end user data. Upon receipt of an user authentication request message that includes a MAC address, the provider system compares the received MAC address against stored MAC address data associated with the end user data. In this manner, the end user computing device can also be authenticated to the provider system. If the received and stored MAC addresses do not match, the provider system returns an authentication decision message indicating the verification failed because the end user computing device could not be authenticated. The provider system can then prompt the user to verifying whether the consumer is using a new device to login to the provider system, and if so, being the process of registering a new device to the provider's system.

The provider stores a wide variety of information relating to end users within an End User Database. The End User Database comprises database records that correspond to individual end users. The end user database records include, without limitation: (i) an user identification, such as first name, surname, middle name, an username, or user identification number; (ii) user contact data, including a mailing address or a geographic region where the user resides (e.g., a zip code, city, state); (iii) user source data, such as user telephone number data, user device IP Address data, an email address, or a social media account name; (iv) user demographic data, including the gender and age of the end user; (v) one or more product identifications that indicate the accounts or products currently held by a user (e.g., a checking account, credit card account, etc.); (vi) user resource availability data (e.g., balances for various product types or account types associated with, or held by, a user); (vii) average resource availability data that indicates the average value of products or account balances maintained by the user over a given time period (e.g., an average monthly balance for an account held by the user); (viii) transaction data that includes data and information relating to user transactions, such as payment amounts, dates when a transaction occurred, data that identifies other parties to the transaction (i.e., a payment recipient), and information identifying a category of expenditures for the transaction (i.e., groceries, transportation, etc.); (ix) average resource utilization volume data indicating the average number of transactions an end user conducts using a given product over a given time period (e.g., the number of resource expenditures per month for a given account or accounts); (x) system configuration data; or (xi) remote connection data.

Remote connection data is end user data and remote provider data associated with the remote connection. The end user has an account with the remote provider that stores data relating to the remote connection, including, without limitation: (i) a remote network user identification, such as a user name or identification number; (ii) stored transfer source data, such as a credit card number or bank account number and routing information that is stored with the remote provider and used to process payments; (iii) plan data that relates to the package of goods, services, or content the end user receives through the remote connection (e.g., a basic account plan, premium account plan, etc.); (iv) user permission data indicating the end users that are authorized to use the remote connection and what operations the end users are allowed to perform (e.g., an administrator may perform any function, but child user cannot access stored transfer source data); (v) remote connection transfer data, such as account statements or electronic transaction data reflecting payments to the remote provider; (vi) remote connection activity data, which can be data reflecting end user utilization of the remote connection for delivery of goods, services, or content; (vii) remote connection security data, which can be end user passwords, stored system configuration data used to authenticate end user computing devices, first party provider network security data used to authenticate the first party provider network, as described in more detail below; (viii) remote connection parameters used to establish a connection with the first party provider network; and (ix) service delivery data that comprises data transmitted to and from the end user computing device as part of the remote provider rendering goods, services, or content to the end user (e.g., content data such as movies or music or data exchanged as part of operating a software-as-a-service).

The End User Database may also store transfer activity data relating to payments or resource transfers to and from an end user account. Transfer activity data can include, but is not limited to: (i) utilization value data representing the value of resources utilized during transaction; (ii) transfer event sequencing data (e.g., a date and time that a given transaction occurred or that otherwise indicates when one transaction occurred relative to another); (iii) a transaction identification, such as a number or alphanumeric code that identifies or characterizes a transaction during which resources were transferred; (iv) a destination identification, which can be a name or identification number (e.g., an employer identification number (“EIN”) or tax ID) of another party to a payment transaction, such as a remote provider or a retailer that accepts payment from an end user, or an individual or employer that makes a payment to a user; (v) transaction location data that indicates where a given transaction occurred (e.g., a zip code, city, or state); (vi) transfer classification data, such as an alphanumeric code, word, or phrase that categorizes a resource transfer or transaction and that can relate to the purpose for which resources are transferred (e.g., transportation expense, housing, groceries, or a paycheck from an employer, or an alphanumeric code representing such a category, such as a Merchant Category Code).

Operation of a remote connection is discussed in more detail below. The term “remote connection” refers to an account that an enterprise or individual end user has establish with a remote provider as part of receiving goods, services, content, or other items of value from the provider. The account comprises a compilation of data relating to the end user and relating to the goods, service, or content rendered by the provider (i.e., the remote connection data).

The goods, services, content, can be provided by a remote provider on a periodic basis or an on-demand basis when ordered or requested by the end user. The example embodiments described in this application generally refer to subscription accounts where end users pay a periodic amount of money (e.g., monthly, quarterly, or yearly) in exchange for goods, services, or content. Example remote providers include, without limitation, a brick-and-motor enterprise (e.g., a fitness club or gym), a content streaming service that broadcasts music or movies on-demand, a software-as-a-service provider (e.g., cloud storage or business accounting software accessible through an online portal or an e-discovery software platform used by lawyers practicing litigation), a retailer that provides goods to an end user periodically or on-demand (e.g., Amazon Prime®). As used in this application, the term “remote provider” is distinct from the “first party provider,” which is an enterprise that hosts the system that end users utilize to operate remote connections through the Remote Connection GUI, as discussed below.

### Operation of Remote Connections

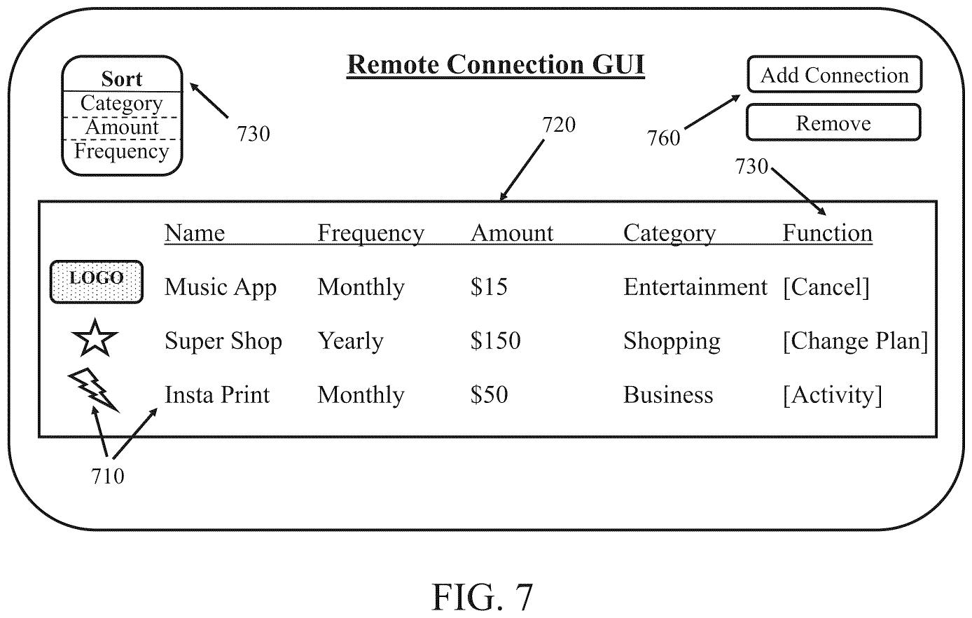

The provider system generates interface assembly instructions that are processed by an end user computing device to generate one or more Remote Connection GUIs. The Remote Connection GUIs allow end users to operate remote connections. An example Remote Connection GUI is shown in FIG. 7 and includes: (i) remote connection identifications 710 that can be alphanumeric text alone or in combination with a graphical icon representing a remote connection; (ii) connection resource utilization data 720 that quantifies the resource utilization attributable to the remote connection, which is commonly displayed as a periodic utilization over time (i.e., monthly, quarterly, or yearly utilization); (iii) remote connection control functions 730 used to execute operations to manage remote connections; (iv) a sort control component 750 that displays the remote connection identifications in an order according to sort parameters; and (v) Add and Remove control components 760 that allow end users to add or remove remote connection identifications for remote connections to be operated by end users.

Remote connection identifications are added manually by end users or automatically by the provider system. Similarly, end users can specify a category or classification for the remote connection identification, or the category can be determined by the system automatically as a classification code used to display the classification on a user interface. Classifications describe the goods, services, or content rendered as part of the remote connection, such as entertainment, shopping, cloud storage, or educational. End users add a remote connection by selecting the Add control component and entering alphanumeric data that identifies the remote connection, such as a remote provider name or a remote connection identification number. The system compares the data entered by the end user against a known remote connection database.

The known remote connection database can include a wide variety of information associated with each remote connection, such as an IP address, website address, a remote provider identification, a remote provider icon, a classification, or remote connection parameters used by the provider system to interface with the remote provider network. For example, an end user might enter Netflix® as the remote provider name. The system searches the known remote connection database to determine IP address information for Netflix®, an icon such as a trademarked logo, remote connection parameters, and a classification of entertainment. If the provider system does not find a match in the known remote connection database or finds multiple possible matches, the system prompts the end user to enter additional data, such as a website address or selecting from a list of potential matches.

The system automatically identifies remote connections and classifications using rules engine software alone or in combination with artificial intelligence technology to analyze end user data, transfer activity data, or navigation data, among other types of information. The rules engine software (e.g., a remote connection identification module or application) applies a set of criteria or rules that match common attributes of a remote connection. Artificial intelligence technology uses transfer activity data, end user data, or navigation data as inputs to a neural network. The neural network outputs one or more remote provider identifications that have a probability above a specified threshold of being a remote connection (e.g., a 98% likelihood or better). The neural network can also output a remote connection classification for each remote connection, such as the classification with the highest probability of being correct and that is above a certain minimum threshold probability (e.g., the highest probability that is at least 95% or higher).

The functioning of rules engine software is illustrated with the following simplified examples. In one embodiment, the rules engine software is programmed with a rule that returns transfer destination identifications present in the transfer activity data at a specified frequency or range of frequencies, such as at least once every thirty days or once every calendar month. The rules engine software is also programmed with a rule that returns transfer destination identifications that appear within the transfer activity data on approximately the same day of every calendar month, such as between the fourth and sixth day of every month.

Another rule analyzes periodic transfers to identify those transfers having a resource transfer value within a specified threshold variability from month-to-month, such as within 10% or $10 each month. Consistent frequencies and resource utilization values are taken as indicators of a subscription-based remote connection. As yet another example, the rules engine software is programmed with a rule that returns transfer destination identifications having specified keywords known to be associated with subscription-based remote connections. In some cases, the first party provider pre-authorizes periodic resource transfers such as where an end user has stored credit card or bank account information with a remote provider that is initiating the periodic transfers. The rules engine software will identify the pre-authorization of periodic transfers as potential remote connection subscriptions.

An embodiment utilizing artificial intelligence can likewise perform operations that analyze the transfer activity data to determine the frequency and variability for transfer destination identifications and the presence of keywords. This data is input to a neural network along with end user data, navigation data, or system configuration data.

The use of artificial intelligence technology to identify and classify remote connections is illustrated with the following simplified examples. If historical or training data shows that transfer destination identifications with a frequency of once every thirty days are more likely to be subscription-based remote connections than those with a frequency of once every ninety days, then transfer destination identifications with a frequency of once every thirty days are weighted more heavily in the neural network nodes.

As another example, assume that historical transfer activity data shows end users in a particular geographic area (e.g., Area ABC) or with an age below a certain threshold (e.g., thirty-years-old) are more likely to establish remote connections for music streaming. For end users with demographic data and contact data indicating the end users are less than thirty-years-old and live in Area ABC, those factors are weighted more heavily in a neural network that determines whether a transfer destination identification is a subscription-based remote connection in the category of “entertainment” or “recreation.” The system also analyzes transfer activity data and returns destination identifications having keywords commonly associated with remote connections that enable content streaming. The presence of such keywords is also an input to a neural network that identifies and classifies remote connections.

After the system identifies a transfer destination identification that is a potential remote connection, the system displays a prompt to the end user asking the end user to confirm that the transfer destination identification is, in fact, a remote connection and to confirm the classification. The confirmation step mitigates against potential misidentifications, such as where an end user completes a specific transaction on the same day every month that is not an active digital subscription (e.g., purchases the same materials, from the same place, for the same monthly meeting). The system can also prompt the user to confirm whether certain resource transfers are associated with the remote connection to ensure accuracy of the identification and improve the system's ability to identify future remote connections. For instance, the system presents the user with a series of purchases and asks the user to confirm whether each purchase is a payment for a particular remote connection subscription.

To allow operation of a remote connection, the system first establishes a secure communication session with the remote provider network. Establishing the secure communication session includes operations that authenticate the end user, the end user device, and/or the first party provider system using the techniques described above. Once a secure communication session is established, the first party provider system can request and receive remote connection data and exchange commands with the remote provider network. In some embodiments, the communication session is persistent such that it is automatically established each time an end user utilizes the system to operate a remote connection. Such uses can be days apart or after an end user computing device has restarted. When the end user computing device launches a software application to operate the remote connection through a Remote Connection GUI or otherwise, the secure communication session is established without the end user having to enter security data, such as an username and password.

As part of establishing the secure communication session, the end user computing device can be redirected to a login website or other interface hosted by the remote provider network to enter security data, such as an username and password. The first party provider stores the security data in an encrypted manner to automate or streamline authentication for future communication sessions. The system may also rely on multi-factor authentication techniques that ask end users to verify a code sent by short-messaging-service (“SMS”) text message or email.

The remote provider can optionally authenticates the end user computing device by, for example, requesting a MAC address, software configuration data, or other system configuration data. The requested data is compared against stored system configuration data saved to the remote provider network to determine whether the data matches. The first party provider system can be authenticated to the remote provider network in a similar manner.

Following authentication, the remote provider network issues a token, certificate, or other file (collectively “token”) that is used by the first party provider or end user computing device to automate or streamline authentication prior to future communication sessions. In one embodiment, the token is sent from the first party provider system to the remote provider network to commence future communication sessions where possession of the token is construed as an indicator of authenticity. The token can include an encryption key that is used to decrypt data sent by the remote provider network to the first party provider network as part of commencing or conducting secure communication sessions.

Turning again to FIG. 7, end users operate one or more remote connections using the Remote Connection GUI. End users select a function control component, such cancel, change plan, activity, or change card (not shown). Selecting the “cancel” control component transmits a command to the remote provider network to terminate the remote connection, thereby allowing the end user to cancel an account. A Remote Connection API accepts the cancel command and converts the command to a format that can be processed by the remote provider network.

The other functions similarly pass a command to the Remote Connection API to convert the command into a format that can be processed by the remote provider network. Selecting the “change plan” function prompts the remote provider network to send plan data that is displayed by the end user computing device as options for changing the end user's plan, such as switching from a “premium” plan to a “basic” plan at a reduced cost.

The “change card” control component transmits new transfer source data (e.g., a new credit card number or bank account number) to the remote provider network with instructions to replace the existing stored transfer source data with the new data. Future payments are then made from the account associated with the new transfer source data Selecting the “activity” control component transmits a command to the remote provider network that returns options for end users to select when downloading transfer activity data, such as selecting or inputting a date range. The Remote GUI is modified to include a “download” or “export” control element that is selected by the end user to begin downloading transfer activity data for the remote connection. Those of skill in the art will recognize that the foregoing examples are not intended to be limiting, and the Remote Connection GUI can incorporate other control components for operating a remote connection.

The system further includes a modification software module that analyzes historical transfer activity data, end user data, and remote connection data to generate activity instructions for execution by the end user computing device. The activity instructions comprise recommended actions for end users to perform to optimize resource utilization. The modification software module can be implemented as a rules engine, with artificial intelligence technology, or a combination of both.

In one example embodiment, the modification software module analyzes transfer activity data to identify duplicate instances of transfer destination identifications. The duplicate instances are construed as an end user potentially paying for two remote connections from a remote provider when only one remote connection is necessary. In another example, the modification software module is programmed with a rule that determines the presence of two remote connections with the same classification that are likely to overlap in the content or services provided. The system displays a notification to the end user recommending that the end user utilize the cancel control component to terminate one of the duplicate (or overlapping) remote connections. The notification can be displayed on the Remote Connection GUI or send to the end user computing device by email, text message, or push notification.

In another embodiment, the modification software module includes artificial intelligence technology that analyzes end user data and generates recommended modifications tailored to a given end user. For instance, a neural network analyzes end user data and remote connection data to recognize that there is a high probability a particular end user will not have sufficient funds to fulfill a mortgage payment at some time in the next six months. The neural network also recognizes that considering the end user demographic data, the particular end user likely has one or more remote connections with plan data that significantly exceeds the subscription level utilized by the end user (e.g., the end user needs only a basic plan but is currently subscribed to premium). The modification software module then generates a recommendation that the end user reduce the subscription level to conserve resources and reduce the probability that the end user will not have sufficient resources to fulfill a mortgage payment.

In a further example, the modification software module could recommend changing the stored transfer source data for one or more remote connections if the module recognizes that using a credit card account with a lower interest rate or a higher proportion of “rewards” points will optimize resource utilization. These examples of the modification software module functionality are not intended to be limiting. Skilled artisans will appreciate that any number of rules or artificial intelligence analyses can be used to generate recommended modifications.

The modification software module can be trained using historical transfer activity data, end user data, and remote connection data using the methods described above. The use of specially trained models realizes a number of improvements over traditional methods of generating modification or activity instructions, including generating activity instructions that are more likely to be executed by an end user computing device, as determined by the training data analysis. Further, the systems and methods disclosed herein lead to faster training times and a more accurate model. The system can also recognize anomalies in the data where the analysis shows the output substantially deviates from the training data. For instance, the modification module might generate an output indicating that resource transfer values for remote connection data is exceptionally high but that the high output is an anomaly that does not require execution of activity instructions.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A system for operating remote connections comprising a computer that includes a processor and a memory device storing data and executable code that, when executed, causes the processor to:
(a) determine that transfer activity data comprises transfers conducted as part of a plurality of remote connections, wherein each of the remote connections is configured to enable the transmission of remote connection data between an end user computing device and a remote network;
(b) establish a secure communication session with each of the remote networks; and
(c) transmit a command to a first remote network that implements a first remote connection in response to the selection of a function control component, wherein the command
(i) modifies remote connection data stored to the first remote network, or
(ii) causes the first remote network to return remote connection data that is incorporated into interface assembly instructions transmitted to the end user computing device to generate a user interface for display.

2. The system for operating remote connections of claim 1, wherein:
(a) the command is a cancel function; and
(b) the first remote network processes the cancel function to terminate the first remote connection.

3. The system for operating remote connections of claim 1, wherein:
(a) the command is a modify plan function; and
(b) the first remote network processes the modify plan function to modify remote connection data by modifying a subscription level, wherein modifying the subscription level reduces resource utilization through the first remote connection.

4. The system for operating remote connections of claim 1, wherein:
(a) the command is an activity function; and
(b) the first remote network processes the activity function to return remote connection transfer data according to an end user selection.

5. The system for operating remote connections of claim 1, wherein the system comprises a Remote Connection application programming interface (API) that converts the command to a format that complies with a communication protocol utilized by the first remote network.

6. The system for operating remote connections of claim 1, wherein:
(a) the system further comprises a neural network; and
(b) the neural network performs the operation to determine that transfer activity data comprises transfers conducted through a plurality of remote connections.

7. The system for operating remote connections of claim 6, wherein the neural network comprises an architecture selected from one of a convolutional neural network architecture, Long short-term memory network architecture, or a recurrent network architecture.

8. The system for operating remote connections of claim 1, wherein the processor executes a further operation of searching transfer destination identifications for keywords that match known remote connections as part of the processor performing the operation to determine whether the transfer activity data comprises transfers conducted as part of the plurality of remote connections.

9. The system for operating remote connections of claim 1, wherein:
(a) the processor executes a further operation to classify the first remote connection to generate a classification code; and
(b) the classification code is transmitted to an end user computing device for display.

10. The system for operating remote connections of claim 9, wherein:
(a) the system further comprises a neural network; and
(b) the neural network performs the operation to classify the first remote connection.

11. The system for operating remote connections of claim 1, wherein:
(a) the processor executes a further operation to generate activity instructions for execution by the end user computing device; and
(b) executing the activity instructions reduces resource utilization through the first remote connection.

12. The system for operating remote connections of claim 11, wherein:
the system further comprises a neural network; and
(b) the neural network performs the operation to generate activity instructions for execution by the end user computing device.

13. A system for operating remote connections comprising a computer that includes a processor and a memory device storing data and executable code that, when executed, causes the processor to:
(a) identify a plurality of remote connections, wherein each of the remote connections
(i) has a transfer destination identification,
(ii) is configured to enable the transmission of remote connection data between an end user computing device and a remote network,
(iii) is implemented by a remote provider, and
(iv) requires periodic resource transfers approved by an end user to maintain the remote connection;
(b) establish a secure communication session with the plurality of remote networks without requiring the end user to input security data to the end user computing device; and
(c) transmit a command to a first remote network in response to the end user selecting a function control component on a graphical user interface displayed by the end user computing device, wherein (i) the command is executed by the first remote network, and (ii) in response to receiving the command, the remote network transmits remote connection data for display by the end user computing device.

14. The system for operating remote connections of claim 13, wherein:
(a) the system further comprises connection identification software code; and
(b) the connection identification software code executes the operation to identify a plurality of remote connections by applying a set of rules to transfer activity data, wherein the set of rules determines transfer activity data that matches a known remote connection.

15. The system for operating remote connections of claim 13, wherein:
(a) the system further comprises connection identification software code; and
(b) the connection identification software code executes the operation to identify a plurality of remote connections by searching each of the transfer destination identifications for keywords that match a known remote connection.

16. The system for operating remote connections of claim 13, wherein:
(a) the command is a cancel function; and
(b) the first remote network processes the cancel function to terminate the first remote connection.

17. The system for operating remote connections of claim 13, wherein:
(a) the command is a modify plan function; and
(b) the first remote network processes the modify plan function to modify remote connection data by modifying a subscription level, wherein modifying the subscription level reduces resource utilization through the first remote connection.

18. A system for operating remote connections comprising a computer that includes a processor and a memory device storing data and executable code that, when executed, causes the processor to:
(a) identify a plurality of remote connections, wherein each of the remote connections
(i) has a transfer destination identification,
(ii) is configured to enable the transmission of remote connection data between an end user computing device and a remote network, and
(iii) is implemented by a remote provider;
(b) establish a secure communication session with each of the remote networks;
(c) receive remote connection transfer data from the remote network;
(d) generate interface assembly instructions that comprise a plurality of transfer destination identifications, control components, and remote connection transfer data, wherein
(i) the control components comprise a cancel function, a modify plan function, and an activity function,
(ii) the control components are configured for selection by an end user, and
(iii) the interface assembly instructions are transmitted to an end user computing device;
(e) receive a command in response to the end user selecting a control component;
(f) transmit the command to a first remote network.

19. The system for operating remote connections of claim 18, wherein the system further comprises a Remote Connection application programming interface (API) that, prior to transmitting the command to the first remote network, converts the command to a format utilized by the first remote network.

20. The system for operating remote connections of claim 18, wherein
(a) the system further comprises a neural network; and
(b) the neural network performs the operation to identify a plurality of remote connections based on transfer activity data and end user data.
